(19) United States
(12) Patent Application Publication
(10) Pub. No.: US 2010/0290448 A1
(43) Pub. Date: Nov. 18, 2010

(54) PRE-FETCHING OF INPUT DATA FOR ACCESS NETWORK SELECTION

(75) Inventor: Johan Rune, Lidingo (SE)

Correspondence Address: ERICSSON INC., 6300 LEGACY DRIVE, M/S EVR 1-C-11, PLANO, TX, 75024, US

(73) Assignee: TELEFONAKTIEBOLAGET L M ERICSSON (PUBL), STOCKHOLM (SE)

(21) Appl. No.: 12/812,674

(22) PCT Filed: Jan. 15, 2008
(86) PCT No.: PCT/SE2008/000031

§ 371 Date: Jul. 13, 2010

(51) Int. Cl. H04W 8/00

(52) U.S. Cl. 370/338

(57) ABSTRACT

The present invention relates to a method, an Access Selection Server and a communication network for network access selection.

### TECHNICAL FIELD

The present invention relates to a method and a communication system for network access selection and an access selection server in the system enabling said method.

### BACKGROUND

Third generation mobile systems (3G), based on WCDMA (Wideband Code Division Multiple Access) radio access technology, are being deployed on a broad scale all around the world. However, as user and operator requirements and expectations will continue to evolve a new phase in the standard specification body called 3^{rd} Generation Partnership Project (3GPP) has started to consider the next major steps in the evolution of the 3G standard. The terminals used in the network are having more functions integrated which means that an increasing number of access types such as e.g. LTE (Long Term Evolution), WiMAX (Worldwide Interoperability for Microwave Access) and WLAN (Wireless Local Area Network) and new services such as Voice over IP (VoIP) or IP-TV are added to the terminal.

In a multi-access environment the multi-interface terminal is often faced with a choice of potential access networks to connect to, either for a new connection or for a potential handover of an existing one or simply for being reachable through after power on.

These access networks may differ in various properties, such as access technology (e.g. 3G or WLAN), available operators (directly or indirectly) and roaming agreements, presence of NATs and/or firewalls, applicable policies (such as codec restrictions), access rate, supported QoS and current load. All these variable parameters make the choice of access network(s) potentially complex. The more data about the available access networks that the access selection algorithm takes into account, the more sophisticated and accurate (and thus beneficial) the selection can be made.

Some of this information is available through scanning of system information that is broadcast from access points or base stations and that can be received by any terminal (equipped with a matching interface) without any type of prior association, registration, authentication or connection.

However, retrieval of other parts of the information, potentially most of it, requires IP level communication, which in turn implies that the terminal has to go through all the preceding procedures that are needed to establish IP level communication. In for example a WLAN network this means that the terminal first has to associate with the access point at the MAC layer, then in most cases go through the user authentication and authorization procedure, typically using Extensible Authentication Protocol (EAP), and finally request and receive IP configuration data through Dynamic Host Configuration Protocol (DHCP).

It is first after all these procedures that the terminal can retrieve some of the information that may be required to select which of the available access networks that it should connect to. That is, the terminal actually has to connect to an access network in order to retrieve access selection input data. This implies an additional effort, unless the terminal already is connected.

Furthermore, retrieving such information related to a particular access network may be difficult using IP communication via another access network. Instead the terminal may have to connect to the particular concerned access network. The reason is that with the currently proposed techniques for locating an access network's local network profile, in which much of the interesting information is expected to be stored, relies on information conveyed in DHCP option 15 during the DHCP configuration procedure.

The DCHP-related technique is for instance described in the internet-draft “A Framework for Session Initiation Protocol User Agent Profile Delivery”, written by D. Petrie and published October 2006. This document specifies a framework to enable configuration of Session Initiation Protocol (SIP) User Agents in SIP deployments. The framework provides a means to deliver profile data that terminals need to be functional, automatically and with minimal (preferably none) user and administrative intervention. The framework describes how SIP User Agents can discover sources, request profiles and receive notifications related to profile modifications.

Since DHCP relies on subnet broadcasting and hardware addresses, it is only available through the particular access network and not via routers from another access network. As an unfortunate consequence the terminal in practice has to connect to each available access network in order to retrieve the information that serves as input data to the selection of which access network to connect to. Even if workarounds would appear for the limitation of the DHCP-based local network profile retrieval, the terminal would still have to connect to at least one access network in order to retrieve the relevant information from all the available access networks to enable sophisticated access selection.

Consequently, connecting to an access network and establishing IP level communication (with all its preceding procedures) with subsequent information retrieval can be rather time consuming and could consequently make the access selection inconveniently slow. It is even worse if the terminal has to connect not only to one, but to all the available access networks. The problem is the most severe when the terminal is not already connected to an access network and the access selection concerns a new connection.

Previous access selection solutions are either terminal-controlled, network-controlled or a combination of both (or the trivial method: user-controlled access selection). Network-controlled access selection is typically used for controlling handover in cellular networks. More accurately this access selection is network-controlled but terminal-assisted—the network's decision relies on reports of measured radio signal strengths from neighbouring base stations. In networks based on IETF protocols, relying on Mobile IP for mobility and session continuity, handovers and their associated access selection are typically entirely terminal-controlled. For access selection during the initial connection to a network, before any network connectivity is available, the solutions are inherently terminal-controlled, since no network-based functionality is available.

In one approach to access selection it is proposed to implement so called access awareness functionality (for support and execution of access selection) both in the terminal and in the network. It is implemented as a layer between the application layer and the transport layer (between applications and sockets). The functionality-related signalling is independent (not mixed with other signalling, in particular application control signalling). It assumes simultaneous accesses and applies to individual communication sessions without impact to the service performance. The network-based access awareness functionality is generic and system independent in the sense that it can be applied to Internet based systems as well as cellular systems, such as 3GPP and IP Multimedia Subsystem (IMS).

The applications interface an extended socket mechanism which makes decision about what accesses to use for connection establishment/handover influenced by a set of criteria or descriptions provided by the application at socket creation. The functionality is structured to have a clear separation between the actual decision making process and the actions resulting from access awareness decisions. The access awareness functionality is system wide which means that it is generally distributed between network entities and in particular an end-user terminal and the network side.

The Assumptions/high-level requirements for the functionality includes: support for any application, compatible with any mobility management, support of simultaneous use of different accesses, separated from applications by an interface and extensible to cover other contexts than the current networking capabilities.

A prime task of the network-based functionality is to assist the terminal-based functionality by collecting network-based information on behalf of the terminal, which is filtered and possibly refined before it is sent to the terminal.

The functionality collects events from the system that is needed for access awareness. In this way the terminal and the potentially resource-scarce access link are relieved from some of the potentially demanding information retrieval and processing.

Another potential task of the network-based access awareness functionality is to assist the terminal-based functionality in calculating choices, decisions and/or recommendation in order to offload the terminal of some of this processing, which is expected to be rather intensive. The access awareness assistant performs its tasks on explicit instructions from the terminal or by analyzing contextual information or, possibly in some cases, based on default instructions.

The communication session is per socket basis (individual communication sessions) and a socket request from the application in the terminal triggers the access awareness functionality. The access selection functionality identifies the application from the port numbers in the socket request (and/or possibly other information such as indications of the process originating the socket request) and infers the application's requirements on the communication quality. This, together with policies and other information, such as available accesses and possibly network load, is then used as input data to the access selection decision. The characteristics are provided to the access awareness functionality in the network as “application preferences”. These preferences may express what the functionality is allowed to do on behalf of the application and within which limits it may act. For instance, “I need 128 kbps, but could stretch myself down to 64 kbps, but not lower”.

The purpose of the network-based access awareness functionality is to let users and applications exploit the fact that accesses and access networks have different characteristics. That is to give applications the necessary tools to exploit differences or give the applications enough support so that they do not need to be aware of the different charactertics. Another purpose is to provide means to adapt to existing or changing conditions. That is, for instance to give recommendations to applications, make applications adapt to changing conditions, adapt communications to changing conditions and trigger mobility management actions. The user benefits can be summarized in increased service quality, reduced interference between applications, convenience and reduced costs. The Access Service Provided (ASP) benefits include more satisfied customers, a mechanism to improve service and a new, potential service offering. Benefits for application and contents providers are higher service penetration and usage take rate, more attractive services and potential for better services.

The 3GPP has also initiated activities to develop access selection functionality (also know as multi access terminal steering) for the evolving 3GPP systems being (or expected to be) deployed in an access network environment of increasing multitude and heterogeneity. The access selection work in 3GPP focuses on packet-switched services and on 3GPP context (access technologies such as EGPRS, WCDMA/HSPA and LTE). It works also for non-3GPP context (WLAN, WiMAX, etc.). The target is a (more or less) network-controlled solution, but there will also be some kind of terminal-based access selection functionality.

The 3GPP access selection provides new functionality in the 3GPP architecture with an Access Selection Discovery and Selection Function (ANDSF), which is separate or part of the Policy and Charging Rules Function (PCRF) in the network. The ANDSF has control of all available accesses for the terminal, current network load, RAT etc. The functionality also comprises an access selection function in the terminal, which based on request or information from the network based access selection functionality (ANDSF) performs activation/deactivation/modification or changes of access (es). It finally comprises a reference point between the access selection functions in the terminal and the network and potentially new interfaces between the PCRF and the ANDSF and between the Proxy-Call Session Control Function—P-CFCS (application server) and the ANDSF.

An assumption (which is not valid for the initial phase of access selection in a 3GPP context but which is a natural continuation in future phases) is that the terminal may have multiple accesses that may be active in parallel, so called simultaneous multi-access. The ANDSF further gets access information from the access selection function in the terminal and information from the network (load status etc.). The ANDSF will also have session information on all active accesses for the terminal. An IP connection between the access selection function in the terminal and in the network will be established at activation of the default access network. The connection is used to communicate access selection information between the access selection function in the terminal and the ANDSF. The ANDSF will be able to send activation/deactivation/modification/change requests of an access network, or instructions, policies, rules or information as the basis for such decisions to the access selection function in the terminal.

The objectives of the 3GPP access selection are automated access selection, automated network discovery/selection, tariff-dependent access priorities, definition of preferred network and service-dependent priorities. Example of benefits for the operators are network load management, radio management capabilities, automatic access selection for the user, improved resource efficiency and system usage and minimized handover effects. User benefits are enablement to influence the access selection, reduction of energy consumption in the terminal, selection of zone per cost etc.

The choice of access network is consequently complex and time consuming. There are so many parameters to consider, e.g. access technology, available operators, roaming agreements, presence of NATs, and/or firewalls, applicable policies, access rate, supported QoS, current load etc. The collection of these parameters takes long time. Some of this information is available through scanning of system information that is broadcast from access points or base stations and that can be received without any type of prior association, registration, authentication or connection. However, as described, retrieval of other parts of the information, potentially most of it, requires IP level communication between the terminal and the network. This in turn implies that the terminal has to go through all the preceding procedures that are needed to establish IP level communication. Normally the terminal must connect to each concerned access network in order to retrieve all access selection input data.

In the research community access selection schemes have been developed that rely on functionality in both the terminal and the network, typically with some kind of access awareness assistant or access selection wizard in the network helping the terminal by providing information or recommendations or even making decisions on behalf of the terminal in order to maintain operator control.

However, the network access awareness/access control function acts on explicit instructions from the terminal and/or current contextual information about the terminal's whereabouts and current activities. It is largely dependent on contextual information and/or the explicit instructions from the terminal and remains in a standby mode when the terminal is disconnected from the network. The advanced access selection schemes depend on information that requires IP communication to retrieve—scanning is not enough.

Moreover, gathering a multitude of information from potential access networks over resource scarce and error prone access link is time consuming. The network-based functionality off-loads the terminal-based access awareness/access control functionality, but still needs time to collect and deliver the information. When the information is needed for an access selection decision, it will often take too long time to collect all the input data to enable a timely access selection decision.

Consequently, due to the time delay and the need for an IP communication, today's solutions do not allow swift, sophisticated access selection.

### SUMMARY

The object of the present invention is to remove the above mentioned deficiencies of prior art solutions and to shorten the time for network access selection.

This object is enabled by means of a method for network access selection in a communication network. The network comprises an Access Selection Server (ASS), at least one User Equipment (UE), an Access Selection Client (ASC) arranged in the UE and communication nodes. The ASS collects access selection parameters used for the selection of access network for the network access for the UE in a multi-access environment. The network access enables a traffic bearer for a traffic flow between an application in the UE and a first node. The ASS forwards the access selection parameters and/or processes the access selection parameters and sends the results of the processed parameters to the UE. The parameters forwarded or the results sent by the ASS being access selection information, based on which the ASC performs activation of new network accesses and/or selection, modification, deactivation or change of existing network accesses in order to enable the traffic flow.

What particularly characterizes the method is that the ASS controls at least the collection or the processing of the access selection parameters, the collection or the processing at least being performed when the UE (14) is disconnected from the communication network. Furthermore, the parameters collected or processed when the UE is disconnected from the communication network are forwarded and/or the results of the processed parameters are sent as access selection information by the ASS to the UE when the UE is again connected to the communication network.

This object is also enabled by means of an Access Selection Server (ASS) being adapted for network access selection. The ASS is arranged in a communication network further comprising at least one User Equipment (UE), an Access Selection Client (ASC) being arranged in the UE and communication nodes. The ASS is further adapted to collect access selection parameters used for the selection of access network for the network access for the UE in a multi-access environment. The network access enables a traffic bearer for a traffic flow between an application in the UE and a first node. The ASS further is adapted to forward the access selection parameters and/or process the access selection parameters and send the results of the processed parameters to the UE. The parameters forwarded or the results sent by the ASS being access selection information based on which the ASC performs activation of new network accesses and/or selection, modification, deactivation or change of existing network accesses in order to enable the traffic flow.

What particularly characterizes the ASS is that it is further adapted to control at least the collection or the processing of the access selection parameters. The ASS is further adapted to perform the collection or the processing at least when the UE is disconnected from the communication network. The ASS is further adapted to, when the UE (14) is again connected to the communication network, forward the parameters, collected or processed when the UE is disconnected from the communication network, and/or send the results of the processed parameters, as access selection information to the UE.

This object is finally enabled by means of a communication network for network access selection. The communication network comprises an Access Selection Server (ASS), at least one User Equipment (UE), an Access Selection Client (ASC) being arranged in the UE and communication nodes.

The ASS is adapted to collect access selection parameters used for the selection of access network for the network access for the UE in a multi-access environment. The network access enables a traffic bearer for a traffic flow between an application in the UE and a first node. The ASS further is adapted to forward the access selection parameters and/or process the access selection parameters and send the results of the processed parameters to the UE. The parameters forwarded or the results sent by the ASS being access selection information based on which the ASC performs activation of new network accesses and/or selection, modification, deactivation or change of existing network accesses in order to enable the traffic flow.

What particularly characterizes the ASS is that it is further adapted to control at least the collection or the processing of the access selection parameters. The ASS is further adapted to perform the collection or the processing at least when the UE is disconnected from the communication network. The ASS is further adapted to, when the UE (14) is again connected to the communication network, forward the parameters, collected or processed when the UE is disconnected from the communication network, and/or send the results of the processed parameters, as access selection information to the UE.

One advantage of the invention is that the solution enables swift, sophisticated access selection that takes data into account that cannot be retrieved from the respective candidate access networks through scanning from the terminal, but which requires established IP communication to retrieve. Another advantage it that it is general enough to be applicable in a variety of access selection solutions, including the ones being worked out in the research community_and in the 3GPP. Further advantages will be described in relation to the embodiments.

### BRIEF DESCRIPTION OF THE DRAWINGS

In the following text the invention will be described in detail with reference to the attached drawings. These drawings are used for illustration only and do not in any way limit the scope of the invention:

FIG. 1 Schematically shows the communication system with the Access Selection functionality according to the present invention.

FIG. 2 Schematically shows a flow diagram for the Access Selection functionality.

FIG. 3 Shows a signalling diagram for the Access Selection functionality.

### DETAILED DESCRIPTION

The invention will now be described in detail with reference to embodiments described in the detailed description and shown in the drawings.

The present invention focus on the problem that existing access selection solutions do not allow swift, sophisticated access selection that takes data into account that cannot be retrieved from the respective candidate access networks through scanning from the terminal. Instead it requires established IP communication to retrieve such data. Such network-based information is either gathered by network-based access selection functionality or by the terminal itself, potentially over a resource restricted and possibly delay prone radio connection. When the information is needed for an advanced access selection decision, it often, or even typically, takes too long to collect or process all the relevant input data to enable a timely access selection decision.

The embodiments refer to a method and a telecommunication system for network access selection, an Access Selection Server and an Access Selection Client, in the system enabling said method. The system, the server and the client are adapted to perform the method steps as described in the method. It should be understood by a person skilled in the art that the fact that the system and in particular the system parts perform a method step means that it is adapted to perform said step.

The present invention relates to a method for network access selection comprising an Access Selection Server (ASS) 10 being arranged in a communication network 27, at least one User Equipment (UE) 14, an Access Selection Client (ASC) 21 being arranged in the UE and communication nodes 11, 12.

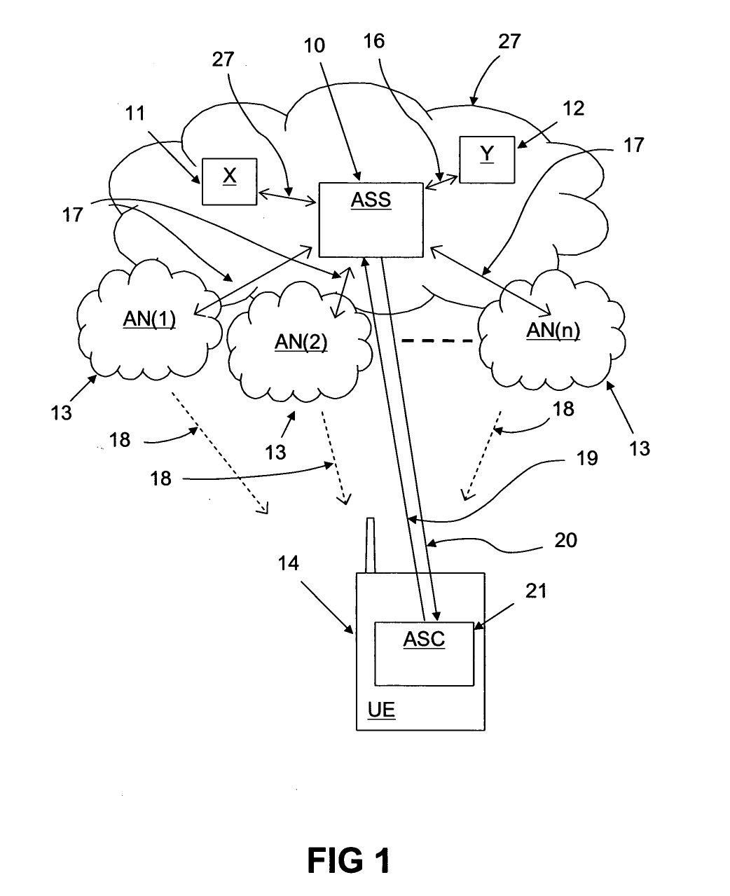

The communication network 27 is illustrated in FIG. 1. The term “node” is herein used in a general sense. It should be understood that different nodes may be integrated into a single node and that the functions represented/employed by a node could also be realized as separate nodes. The ASS 10 is located in the core network. Where it is located depends on which kind of access selection technology that is used (terminal- or network controlled). Examples of selection technologies are described in the background part. The communication nodes X 11 and Y 12 may for instance be databases, profile servers, Authentication/Authorization and Accounting (AAA) server, Home Subscriber Server (HSS), Session Initiation Protocol (SIP) proxies, Home Agents etc. What kind of nodes which are present depends on in which network/sub-network that the access selection function is located.

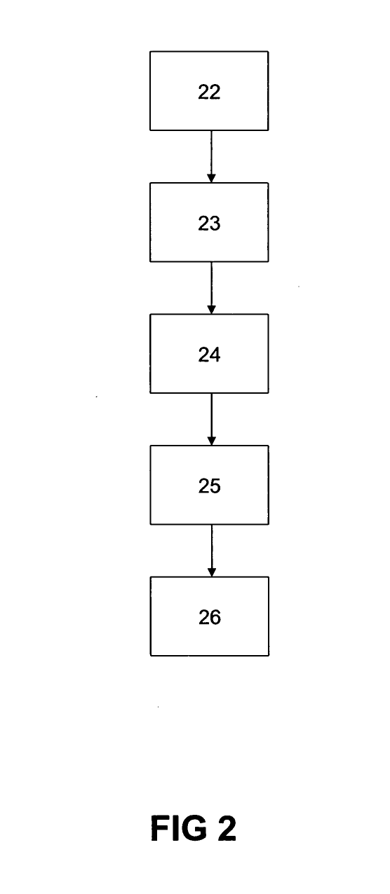

The functionality of the ASS 10, on which the invention is based, is illustrated in FIG. 2. The functionality comprises a learning stage 22 for the behaviour of a control of at least the collecting/receiving or processing of access selection parameters when the UE 14 is disconnected from the communication network 27. It further comprises a step 23 when the collecting/receiving or processing is performed. This is followed by a requesting stage 24 where the UE when being connected to the communication network requests the ASS to send/forward access selection information. During step 25 the ASS sends/forwards the information and at step 26 the UE (the ASC in the UE) performs the access selection, handover or similar. The collecting/receiving is performed via connections 27, 16 and 17 from the nodes 11-12 and the access networks 13. The request is sent via connection 19 and the information is sent/forwarded via connection 20. The functionality will also be described step by step in the following text.

During operation the ASS collects 23 access selection parameters used for the selection 26 of access network for the network access for the UE 14 in a multi-access environment (more than one access network 13). What kind of parameters and how it is used (network or terminal controlled access selection 26) varies, and it should be understood that all kinds of access selection related parameters are included within the term “collected”.

In particular, the ASS during operation receives 23, see FIG. 2, access selection parameters from the nodes 11,12 via the connections 27,16 established using reference points (not described further in this document) corresponding to a certain interfaces. Possible parameters received are e.g. node location information, connection information, disconnection information, network load information, policy-based restrictions and network-based information. The ASS further receives 23 network-based parameters from the different access networks 13 (1, 2 up to n) connected to the core network. This is enabled through a reference point 17. The interfaces referenced 18-20 will be described later.

The network access enables a traffic bearer for a traffic flow between an application in the UE 14 and a first node. A first node is for instance a peer node for peer-to-peer communication, e.g. Voice over IP communication, or an application server for client-server communication. The traffic preferably flows via a PDN-GW, which for instance could be a Systems Architecture Evolution (SAE) Gateway (GW)/Home Agent (HA) in a SAE network in a 3GPP domain or an access router. An application could for instance be VoIP or video calls. A first node is the receiver of the traffic flow from the UE.

The traffic bearer may be enabled between the UE 14 and a Packet Data Network Gateway (PDN GW) and the traffic flow between the application in the UE and a first node is then communicated via the PDN GW.

During operation the ASS 10 forwards 25 the access selection parameters and/or processes the access selection parameters and sends 25 the results of the processed parameters to the UE 14 using connection 20, see FIG. 1-2. The parameters forwarded or the results sent by the ASS are defined as access selection information. Results are network-based filtered and refined information.

From now on reference will be made to the UE 14 including the ASC 21. Since the ASC is included in the UE, the UE is able to perform activities in practise executed by the ASC.

Based on the access selection information, the UE 14, executed by the ASC 21, performs 26 activation of new network access and/or selection, modification, deactivation or change of existing network accesses in order to enable the traffic flow.

Access selection information is for instance instructions to the ASC to select 26 a certain access for the traffic bearer, the instruction being accompanied by for instance Quality of Service and Traffic Flow Template information. As another example the access selection information may be information that serves as input data to an access selection decision in the UE, e.g. rules guiding or directing such an access selection decision or input data in the form of information about the current state of the network(s) or access network(s).

What particularly characterizes the present invention is that the ASS 10 controls at least the collection or the processing 23 of the access selection parameters and that the collection or the processing 23 at least being performed when the UE 14 is disconnected from the communication network 27. The parameters collected or processed when the UE is disconnected from the communication network are forwarded 25 and/or the results of the processed parameters are sent as access selection information by the ASS to the UE when the UE is again connected to the communication network.

In an access selection functionality it is an important task of the ASS 10 to feed 25 the UE 14 with relevant information collected from network-based sources 11, 12, and 13, which are not accessible through scanning from the UE 14. In addition to offloading the UE from some of the collection and processing 23 of information, the inventive solution proposes an adaptive feature in the ASS that allows it not only to provide the UE with relevant information, but also to prepare such information transfers while the UE is disconnected. This enables access selection 26 decisions that are both fast and sophisticated.

The ASS can collect and/or process 23 access selection parameters from various access networks 13. This is made through the reference point 17. What parameters to at least collect or process and from which access networks are normally determined by contextual information, such as the terminal's current point of connection, concerned applications, policy and profile data, etc. The problem with the known access selection technologies is that the ASS 10 can either itself analyze such contextual information received from the UE 14 or base its parameter collection on explicit instructions from the UE. The ASS is then largely dependent on the UE and remains in a standby mode when the terminal is disconnected from the communication network 27.

According to the characterizing part the present invention this dependency is partly removed by enabling the ASS 10 to maintain meaningful activity even when the UE 14 is disconnected from the communication network 27. During such time periods the ASS controls what parameters it should at least collect or process 23 and from which access networks 13 it should collect or process it. The purpose of collecting or processing parameters even when the UE is disconnected from the communication network is to be able to provide 25 the ASC 21 in the UE with relevant access selection information without unnecessary delay as soon as the UE connects to the communication network 27 (and/or when requested by the UE). If the ASS has managed to collect or process parameters that actually turn out to be relevant, this method enables fast and sophisticated access selection 26.

According to one embodiment of the present invention the control by the ASS 10, comprising the control of at least the collection or the processing 23 of parameters by the ASS, is based on contextual information, historical records and/or statistics from the records for the communication network 27 location of the UE. An adaptive learning scheme is located in the ASS and controls at least the collection or the processing 23 of parameters. Also the sending and/or forwarding 25 of access selection information are preferably controlled by the adaptive learning scheme in the ASS.

To be able to adapt the control of at least the collection or processing 23 to the UE's history of movements, connections and disconnections the ASS has to be able to detect (and record) these actions from the UE which constitute the input data to the adaptive scheme.

A key component in the present invention is the control of at least the collection or the processing 23 behaviour by the ASS 10 (the adaptive learning scheme). According to the adaptive scheme the ASS continuously records relevant contextual information and learns 22 from historical records as well as statistics extracted from such records. The control behaviour is then continuously modified accordingly. There are different examples what kind of contextual information that the ASS can learn from:

According to a first example the time period between the disconnecting and the following connecting of the UE 14 to the communication network 27 is controlled. If the period exceeds a certain period value, the control of at least the collection or the processing 23 of parameters is at least based on:
1. Contextual information on where in the communication network 27 the UE is most likely to appear when connecting to the communication network, and

2. Which access network or networks the UE can select from when connecting to the communication network 27.

The statistics is based in information about the selectable access network or networks.

The ASS 10 consequently learns 22 where the UE 14 is most likely to “appear” after a significant period of disconnection and which access networks 13 that it then usually has to select between. The word “appear” is here used as a metaphor for connecting to the communication network 27. From the point of view of the ASS the UE is invisible as long as it is disconnected and visible only when it is connected to the communication network. Thus, in this context and with this “terminology” the word “appear” is a rather descriptive term for the event where the UE changes from being invisible to being visible.

Contextual data may take the shape of an access network 13, one or more access points/base stations, one or more cell(s)/zone(s) or even geographical data. The ASS 10 can learn 22 and maintain statistics about multiple such “locations of probable appearance”. The knowledge acquired in this way allows the ASS 10 to proactively at least collect or process 23 data that is relevant for access selection 26 during initial connections.

In another example of what kind of contextual information that the ASS 10 can learn 22 from, the control of at least the collection the or processing 23 of parameters is at least based on movement pattern that reoccurs frequently.

In this context movement pattern refers to movement between communication network 27 locations.

This means that the ASS 10 learns to which new location the UE 14 is likely to move from a certain current communication network 27 location. A “location” may in this context be an access network 13, an access point(s)/base station(s), one or more cell(s)/zone(s) or a geographical area (e.g. indicating the vicinity of a certain access network, a certain access point/base station or a certain cell/zone). The knowledge learnt 22 in this way allows the ASS to proactively at least collect or process 23 parameters that are relevant for access selection 26 during (potential) handovers. To refine its choice of information sources, the ASS may also take into consideration the currently used application(s).

The acquired knowledge may also be relevant for access selection 26 in a “camping” state, i.e. when the UE 10 is connected/associated with an access network 13, but not actively communicating. Optionally, the ASS 10 may maintain separate statistics on movement patterns for the UE 14 in the “camping” and actively communicating states respectively. An additional option for how to refine the statistics for movement patterns in an actively communicating state (i.e. for the purpose of handovers) is to take the currently used application(s) into account, such that movement pattern statistics per application or application type can be maintained.

In another example of what kind of contextual information that the ASS 10 can learn 22 from the time period between the disconnecting and the following connecting is below a certain period value. The control of at least the collection the or processing 23 of parameters is then at least based on the communication network 27 location where it was last connected.

According to this example, the ASS 10 learns 22 where the UE 14 is most likely to “reappear” after a brief (insignificant) period of disconnection based on the location where it was last connected. The word “reappear” is here used in a similar way as “appear”. The purpose of the prefix “re” is to distinguish the situation where the UE has been “invisible” for the ASS for a limited period (below a certain period value) of time from the situation where the UE has been “invisible” for a significant period (exceeds a certain period value) of time. The former case implies that the UE probably has not moved very long from the location where it was last “visible” for the ASS, whereas in the latter case the UE has had ample time to move even to locations far a way from the one where it was last “visible”.

For instance, if the UE 14 was last disconnected from the communication network 27 in location α, then the ASS may have learnt 22 that if the UE connects to the communication network again within a certain limited period of time (implying a limited movement), it is likely to do this in location 13 (which may well be the same as location a). The definition of “location” in this context is the same as above. A more concrete or precise example could be that if a disconnected UE was last connected in cell X of access network A, then the ASS may have learnt that if the UE reconnects to the communication network within a certain limited period of time, then it will usually do this in cell Y in access network A with access networks B and C also within reach.

This means that when the UE 14 disconnects from cell X of access network A then, unless it is a handover, the ASS 10 starts at least collecting or processing 23 relevant parameters from access networks A (with focus on cell Y if applicable), B and C in order to be able to support quick access selection 26 if the UE 14 reappears (reconnects) as expected. However, if it takes too long before the UE reconnects, the ASS starts at least collecting or processing information according to the principles described above for the case where the UE is disconnected from the communication network 27 during a significant period of time, i.e. from the “location(s)” where the UE most commonly appears after a significant period of disconnection. Thus, the knowledge learnt in this way allows the ASS to proactively at least collect or process parameters that are relevant for access selection 26 during connection(s) in certain situations.

In accordance with one alternative of how the ASS 10 receives 23 information about the communication network 27 location of the UE, it gets information about the communication network location of the UE 14 explicitly. This means that the UE informs the ASS of its communication network location whenever it arrives in a location. The explicit information is the most important. The UE informs the ASS of its location with the detail/granularity needed, e.g. access network, cell, zone, access point, domain name, geographical data etc., whenever it arrives in a location (manifested as connection, handover, movement in idle mode or “camping” state). If the UE moves in a mode in which it is not configured for IP communication, IP configuration is required before explicitly informing the ASS of a new location. It may be argued that it is not beneficial to go to such lengths merely to inform the ASS of the new location of the UE, but it is at least a possible option.

In accordance with another alternative of how the ASS 10 receives information about the communication network 27 location of the UE 14, the ASS gets information about the network location of the UE implicitly. This means that the UE contacts the ASS for other purposes than to inform about its communication network location, during which contact the UE reveals its Internet Protocol address to the ASS.

In another alternative of how the ASS 10 receives information about the communication network 27 location of the UE it is also possible that the ASS can retrieve location information from other entities that possess knowledge about the location of a UE, such as a SIP proxy, a Mobile IP Home Agent, a AAA server or a HSS.

Within one embodiment of the present invention the Uniform Resource Identifier (URI) of an access network's local network profile is sent by the UE 14 to the ASS 10 when being connected to the communication network 27. The URI may be delivered to a UE in Dynamic Host Configuration Protocol (DCHP) option 15 during the DCHP configuration procedure. In some cases it is possible that the relevant information cannot be located without prior information that is only available through scanning 18, see FIG. 1, or by connecting to a certain access link. One example is this retrieval of a local network profile located through a URI that is delivered in DHCP option 15. Since DHCP relies on link-local mechanisms like broadcast, this URI can only be retrieved by a device connected to the concerned access network. In cases like this, the UE will transfer to the ASS 10 the information that is required to locate certain relevant information, e.g. in the form of a URI for a local network profile or a domain name for information in general.

The UE 14 will do this opportunistically, i.e. any time that the UE has contact with the ASS 10 and concerning any information that may potentially be relevant for the ASS to retrieve. Out of the information of this type that the ASS receives from the UE, it may choose to retain only a selected part that turns out to be useful within a reasonable time. In other words, information of this type that the ASS does not use is eventually timed out and deleted.

Within one embodiment of the present invention the UE 14 subscribes to certain events from the ASS 10. The ASS continuously monitors the information sources that are relevant for the subscribed events and when a criteria for a subscribed event is fulfilled the ASS sends a notification to the UE. Such events may e.g. be changes in policies, Quality of Service support or load. The ASS continuously monitors the information sources that are relevant for the subscribed events and when the criteria for a subscribed event are fulfilled, the ASS sends a notification to the UE.

The sending and/or forwarding 25 of information are preferably controlled by the ASS 10. The access selection information is preferably sent/forwarded to the UE 14 through the interface 20. The access selection information is not available through scanning from the UE.

The notion of the ASS controlling the sending and/or forwarding 25 of information may constitute that the ASS determines which information and/or which type of information that is appropriate to send/forward to the UE in each particular situation.

The notion of the ASS controlling the sending and/or forwarding 25 of information may also constitute that the access selection information is sent and/or forwarded 25 to the UE when requested by the UE. Such a request is sent when the UE is again connected to the communication network 27. The request may optionally be sent immediately when the UE connects to the communication network. The request is sent via a communication interface 19 between the ASS and the ASC. FIG. 2 illustrates this alternative.

Proactively collected 23 parameters (as well as more reactively collected parameters) are typically transferred 25 to the UE 14 on request 24, i.e. the UE retrieves the access selection information from the ASS 10. When an access selection 26 situation arises in the ASC 21 in the UE 14 and the decision requires input data that can beneficially (or only) be collected by the ASS 10, then the UE requests the ASS to at least collect or process the concerned parameters and transfer it as access selection information to the UE.

If the ASS's adaptive, proactive behaviour has been successful and the requested 24 parameters consequently are already at least collected or processed 23, then the ASS can transfer 25 it as access selection information to the UE immediately. Otherwise, the ASS has to collect or process 23 the requested parameters before it can transfer 25 it to the UE. From the UE's point of view these two situations differ only in how quick the UE receives the requested access selection information from the ASS.

There are two major cases of access selection 26 in the context of the UE requesting access selection information from the ASS 10. In one case the UE 14 requests 24 the access selection information from the ASS via anyone of the access networks 13 that the UE is connected to. This for instance relate to access selection 26 for handover of a connection or access selection 26 for a new connection request from an application when the UE is already connected. If the UE is connected to one or more access network(s) when the access selection situation arises, it can use any one of the connected accesses to send its request 24 for access selection information to the ASS.

The other case relates to access selection when the UE is not connected to an access network, e.g. for access/cell selection in idle mode (also known as access selection for “camping”) or access selection for a connection (socket) request from an application when the terminal is disconnected/idle.

If the UE 14 is not connected to an access network 13 when the access selection situation arises, it has to connect to one of the available access networks before requesting 24 the information from the ASS. Which one of the available accesses to choose for this communication may be governed by default policies (with information retrieved through scanning as input data, possibly enhanced with old, cached contextual data, such as application usage history and additional information about the discovered access networks). If the access selection 26 is only for idle mode (in the sense that no IP configuration is required) then it may not be considered worthwhile to connect to an access network (going through authentication and IP configuration etc.) merely to be able to retrieve information from the ASS and consequently it is an option to rely only on information that can be retrieved through scanning or from within the terminal in such situations.

The notion of the ASS controlling the sending and/or forwarding 25 of information may finally constitute in that the ASS (10) sends and/or forwards the access selection information to the UE (14) after receiving an indication from another network entity that the UE has connected to one of the available access networks. The ASS consequently transfers access selection information to the UE without a prior request, when it receives an indication from another network entity, e.g. an AAA server that the UE has connected to the communication network 27 (provided that the ASS has a means to appropriately address the UE with this information transfer).

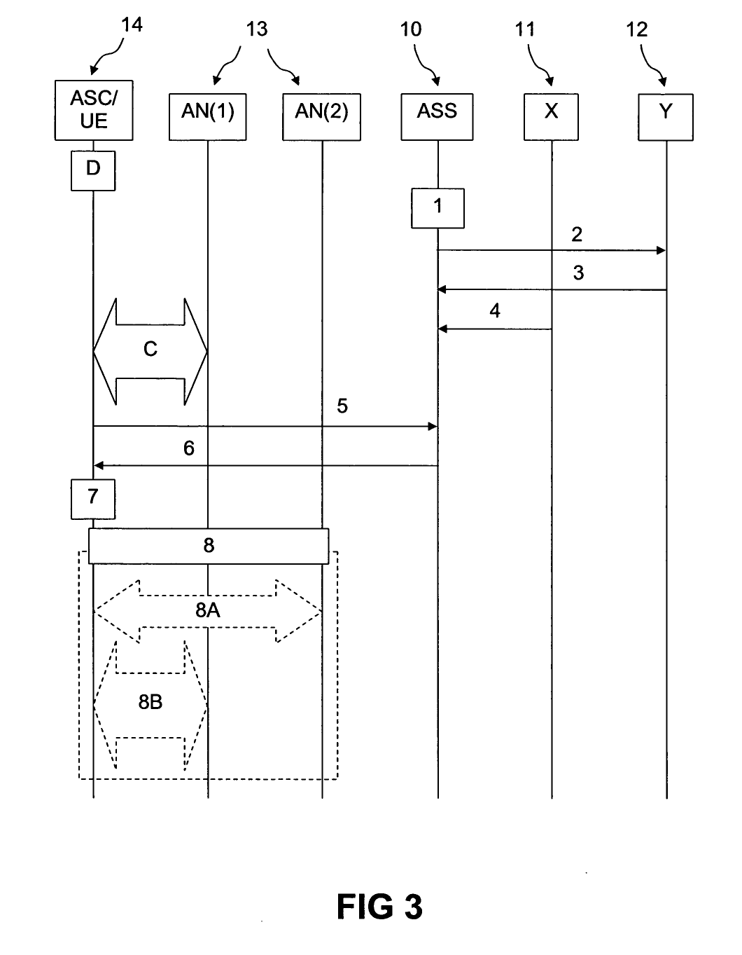

FIG. 3 shows a signalling diagram illustrating the Access Selection functionality according to the present invention. When the UE 14 is disconnected D from the communication network 27, the ASS 10 checks 1 historical records, statistics etc. in order to control at least the collection or processing of parameters. The ASS further requests 2 and receives 3 network-based information from the network based entity X 11 and receives 4 unsolicited network-based information from the network-based entity Y 12Y 12. The communication nodes X and Y may for instance be databases, profile servers, Authentication/Authorization and Accounting (AAA) server, Home Subscriber Server (HSS), Session Initiation Protocol (SIP) proxies, Home Agents etc.

When the UE 14 again connects C to for instance access node 1 (AN (1)) 13 it sends 5 location information and a request for access selection information to the ASS. The ASS 10 sends 6 back such information to the ASC 21 in the UE. Then ASC in the UE then processes 7 the access selection information.

Depending on the outcome of the processing 7 by the UE, certain actions 8 are performed. As a possibility the UE connects 8A to access node 2 (AN(2)) 13 and possibly disconnects 8B from AN(1) 13.

It will also be appreciated by a person skilled in the art that various modifications may be made to the above-described embodiments without departing from the scope of the present invention.

1. A method for network access selection in a communication network comprising an Access Selection Server (ASS), at least one User Equipment (UE), an Access Selection Client (ASC) being arranged in the UE and communication nodes,
the ASS collecting access selection parameters used for the selection of access network for the network access for the UE in a multi-access environment,
the network access enabling a traffic bearer for a traffic flow between an application in the UE and a first node,
the ASS forwarding the access selection parameters and/or processing the access selection parameters and sending the results of the processed parameters to the UE,
the parameters forwarded or the results sent by the ASS being access selection information based on which the ASC performs activation of new network accesses and/or selection, modification, deactivation or change of existing network accesses in order to enable the traffic flow,
the ASS controls at least the collection or the processing of the access selection parameters, the collection or the processing at least being performed when the UE is disconnected from the communication network, and
the parameters collected or processed when the UE is disconnected from the communication network are forwarded and/or the results of the processed parameters are sent as access selection information by the ASS to the UE when the UE is again connected to the communication network.

2. The method according to claim 1 wherein the control by the ASS of at least the collection or the processing of parameters is based on contextual information, historical records and/or statistics from the records for the communication network location of the UE.

3. The method according to claim 2 wherein an adaptive learning scheme being located in the ASS controls at least the collection or the processing of parameters.

4. The method according to claim 2 wherein if the time period between the disconnecting and the following connecting exceeds a certain period value, the control of at least the collection or the processing of parameters is at least based on:
contextual information on where in the communication network the UE is most likely to appear when connecting to the communication network, and
which access network or networks the UE can select from when connecting to the communication network.

5. The method according to claim 4 wherein the statistics is based in information about the selectable access network or networks.

6. The method according to claim 2 wherein the control of at least the collection or the processing of parameters is at least based on movement patterns that reoccurs frequently, the patterns being movement between communication network locations.

7. The method according to claim 2 wherein if the time period between the disconnecting and the following connecting is below a certain period value the control of at least the collection or the processing of parameters is at least based on the communication network location where it was last connected.

8. The method according to claim 2 wherein the ASS gets information about the communication network location of the UE explicitly, in which the UE informs the ASS of its communication network location whenever it arrives in a location.

9. The method according to claim 2 wherein the ASS gets information about the communication network location of the UE implicitly, in which the UE contacts the ASS for other purposes than to inform about its communication network location, during which contact the UE reveals its Internet Protocol address to the ASS.

10. The method according to claim 1 wherein the access selection information is not available through scanning from the UE.

11. The method according to claim 1 wherein a Uniform Resource Identifier (URI) of an access network's local network profile, is sent by the UE to the ASS when being connected to the communication network.

12. The method according to claim 1 wherein the UE subscribes to certain events from the ASS, the ASS continuously monitoring the information sources that are relevant for the subscribed events and when a criteria for a subscribed event is fulfilled the ASS sends a notification to the UE.

13. The method according to claim 1 wherein the access selection information is sent and/or forwarded to the UE when requested by the UE.

14. The method according to claim 1 wherein the UE requests the access selection information from the ASS via any of the access networks that the UE is connected to.

15. The method according to claim 1 wherein the ASS sends and/or forwards the access selection information after receiving an indication from another network entity that the UE has connected to one of the available access networks.

16. An Access Selection Server (ASS) being adapted for network access selection, the ASS being arranged in a communication network further comprising at least one User Equipment (UE), an Access Selection Client (ASC) being arranged in the UE and communication nodes, the ASS further is adapted to collect access selection parameters used for the selection of access network for the network access for the UE in a multi-access environment,
the network access enabling a traffic bearer for a traffic flow between an application in the UE and a first node, the ASS further is adapted to forward the access selection parameters and/or process the access selection parameters and send the results of the processed parameters to the UE,
the parameters forwarded or the results sent by the ASS being access selection information based on which the ASC performs activation of new network accesses and/or selection, modification, deactivation or change of existing network accesses in order to enable the traffic flow,
the ASS is further adapted to control at least the collection or the processing of the access selection parameters,
the ASS is further adapted to perform the collection or the processing at least when the UE is disconnected from the communication network, and
the ASS is further adapted to, when the UE is again connected to the communication network, forward the parameters, collected or processed when the UE is disconnected from the communication network, and/or send the results of the processed parameters, as access selection information to the UE.

17. The ASS according to claim 16 wherein the ASS is adapted to perform the control of at least the collection or the processing of parameters on the basis of contextual information, historical records and/or statistics from the records for the communication network location of the UE.

18. The ASS according to claim 17 wherein an adaptive learning scheme located in the ASS is adapted to control at least the collection or the processing of parameters.

19. The ASS according to claim 17 wherein the ASS is adapted to get information about the communication network location of the UE explicitly, in which the UE informs the ASS of its communication network location whenever it arrives in a location.

20. The ASS according to claim 17 wherein the ASS is adapted to get information about the communication network location of the UE implicitly, in which the UE contacts the ASS for other purposes than to inform about its communication network location, during which contact the UE reveals its Internet Protocol address to the ASS.

21. The ASS according to claim 16 wherein the UE subscribes to certain events from the ASS, the ASS is further adapted to continuously monitor the information sources that are relevant for the subscribed events, and when a criteria for a subscribed event is fulfilled the ASS is further adapted to send a notification to the UE.

22. The ASS according to claim 16 wherein the ASS is further adapted to send and/or forward the access selection information to the UE when requested by the UE.

23. The ASS according to claim 16 wherein the ASS is further adapted to send and/or forward the access selection information after receiving an indication from another network entity that the UE has connected to one of the available access networks.

24. A communication network for network access selection, the communication network comprising an Access Selection Server (ASS), at least one User Equipment (UE), an Access Selection Client (ASC) being arranged in the UE and communication nodes,
the ASS is adapted to collect access selection parameters used for the selection of access network for the network access for the UE in a multi-access environment,
the network access enabling a traffic bearer for a traffic flow between an application in the UE and a first node,
the ASS is further adapted to forward the access selection parameters and/or process the access selection parameters and send the results of the processed parameters to the UE,
the parameters forwarded or the results sent by the ASS being access selection information based on which the ASC is adapted to perform activation of new network accesses and/or selection, modification, deactivation or change of existing network accesses in order to enable the traffic flow, characterized in that
the ASS is further adapted to control at least the collection or the processing of the access selection parameters,
the ASS is further adapted to perform the collection or the processing at least when the UE is disconnected from the communication network,
the ASS is further adapted to, when the UE is again connected to the communication network, forward the parameters collected or processed when the UE is disconnected from the communication network, and/or send the results of the processed parameters, as access selection information to the UE.
